(19) United States
(12) Patent Application Publication
(10) Pub. No.: US 2009/0003181 A1
(43) Pub. Date: Jan. 1, 2009

(54) HOLOGRAM RECORDING MEDIUM, HOLOGRAM RECORDER/REPRODUCER, HOLOGRAM RECORDING METHOD, AND HOLOGRAM REPRODUCING METHOD

(75) Inventor: Michio Matsuura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/203,693

(22) Filed: Sep. 3, 2008

Related U.S. Application Data
(63) Continuation of application No. PCT/JP2006/305213, filed on Mar. 16, 2006.

(51) Int. Cl. G11B 7/00

(52) U.S. Cl. 369/103; G9B/7

(57) ABSTRACT

A hologram recording medium (B) includes a recording region (Ba) where a condensation spot (sp) is formed upon being irradiated with an information beam (I) and a reference beam (R) under the interference thereof. A hologram is recorded on each condensation spot (sp). The recording region (Ba) includes a diffraction grating (Dg), which includes a plurality of deficient portions (df) that serve as a sight target for the condensation spot (sp).

This application is a Continuation of International Application Serial No. PCT/JP2006/305213, filed Mar. 16, 2006.

### TECHNICAL FIELD

The present invention relates to a hologram recording medium used for recording and reproducing holograms, a hologram recorder/reproducer, a hologram recording method, and a hologram reproducing method.

### BACKGROUND ART

Examples of conventional devices for recording and reproducing holograms include those disclosed in patent documents 1 and 2 listed below. The hologram recorder/reproducers of the patent documents 1 and 2 are characterized by a positioning mechanism for adjusting a sight target position on a hologram recording medium, to which the information beam and the reference beam are to be emitted.

The hologram recorder/reproducer according to the patent document 1 employs a hologram recording medium having a multitude of recessed markers formed along the track, to which a servo beam of a different wavelength from that of the information beam and the reference beam is emitted. With such an arrangement, the servo beam is focused on the desired marker, and then the information beam or the reference beam is emitted to that marker, thereby recording or reproducing a hologram.

The hologram recorder/reproducer according to the patent document 2 employs a hologram recording medium having a recording layer on its front surface, and a multitude of recessed portions formed on its rear surface. The hologram recording medium is irradiated with the information beam or the reference beam from the front surface side, and a reconstruction beam generated upon emitting only the reference beam is detected on the front surface. The servo beam is obtained by splitting a laser beam emitted by a single light source into a different optical path from the information beam and the reference beam. The servo beam is emitted from the rear surface side of the hologram recording medium. Under such configuration, the servo beam adjusts the focal point at the desired recessed portion, after which the information beam or the reference beam is emitted to the position on the front surface of the recording medium corresponding to that recessed portion, thereby recording or reproducing a hologram.
Patent document 1: JP-A-2002-63733
Patent document 2: JP-A-2005-243062

The hologram recorder/reproducer of the patent document 1 requires, however, a number of additional optical components such as a light source for the servo beam and optical lenses, in addition to the optical system including the information beam and the reference beam, thereby making the optical system more complicated and larger in scale.

In the hologram recorder/reproducer of the patent document 2, the laser beam emitted by the single light source is split into the information beam, the reference beam and the servo beam. Thus, the power output of the light source for emitting the laser beam needs to be increased so that a sufficient amount of light is provided for the servo beam. In this manner, however, the focusing may fail to be accurately performed with respect to the target recessed portion.

### DISCLOSURE OF THE INVENTION

The present invention has been proposed under the circumstances described above. An object of the present invention is to provide a hologram recording medium and a hologram recorder/reproducer, a hologram recording method, and a hologram reproducing method, that allow simplifying the optical system necessary for recording and reproducing a hologram, yet enables accurate adjusting of a target point of an information beam and a reference beam.

To achieve the foregoing object, the present invention adopts the following technical measures.

A first aspect of the present invention provides a hologram recording medium that comprises a recording region on which a condensation spot is formed upon being irradiated with an information beam or a reference beam, so that a hologram is recorded at each condensation spot. The recording region includes a diffraction grating, and this diffraction grating includes a plurality of deficient portions to serve as a sight target for the condensation spot.

Preferably, a grating interval of the diffraction grating is set such that a zero-order diffracted beam and a first-order diffracted beam generated when the information beam or the reference beam is emitted overlap each other in a peripheral region.

Preferably, the plurality of deficient portions are provided at regular intervals.

Preferably, the plurality of deficient portions are provided so as to form a plurality of rows.

Preferably, the plurality of deficient portions are divided into a plurality of groups, such that each group has a different arrangement pattern.

Preferably, the diffraction grating is formed of a plurality of projections or recessed portions aligned at regular intervals, and the deficient portion is a region where the projections or the recessed portion is locally unprovided.

A second aspect of the present invention provides a hologram recorder/reproducer, comprising a hologram recording medium including a recording region on which a condensation spot is formed upon being irradiated with an information beam or a reference beam, and a diffraction grating formed on the recording region and including a plurality of deficient portions that serve as a sight target for the condensation spot, so that a hologram is recorded on each of the deficient portions; an information beam emitter that emits the information beam to the hologram recording medium; a reference beam emitter that emits the reference beam to the hologram recording medium; an optical receiver that receives a reconstruction beam output by the hologram recording medium for reconstruction; and a control unit that irradiates, in a recording process, the recording region with the information beam or the reference beam so as to form a moving spot thereon, and causes the optical receiver to receive a diffracted beam thereby created by the diffraction grating, so as to adjust the focal point of the information beam and the reference beam at the deficient portion where recording is to be executed, based on a detection signal from the optical receiver.

Preferably, the control unit irradiates, in a reproducing process, the recording region with a part of the information beam and the reference beam so as to form the moving spot including a blank at a central portion, and causes the optical receiver to receive the diffracted beam created by the diffraction grating, thereby adjusting the focal point of only the reference beam at the deficient portion, based on the detection signal from the optical receiver.

A third aspect of the present invention provides a hologram recording method, comprising employing a hologram recording medium including a recording region on which a condensation spot is formed upon being irradiated with an information beam or a reference beam, and a diffraction grating formed on the recording region and including a plurality of deficient portions that serve as a sight target of the condensation spot; irradiating the hologram recording medium with the information beam or the reference beam so as to record a hologram on each of the deficient portions; irradiating the recording region with the information beam or the reference beam so as to form a moving spot; detecting a diffracted beam thereby generated by the diffraction grating; and adjusting, based on the detection result, the sight target of the information beam and the reference beam to the deficient portion which serves as the recording position.

A fourth aspect of the present invention provides a hologram reproducing method, comprising employing a hologram recording medium including a recording region on which a condensation spot is formed upon being irradiated with an information beam or a reference beam, and a diffraction grating formed on the recording region and including a plurality of deficient portions that serve as a sight target of the condensation spot, each of the deficient portions including a hologram recorded thereon; irradiating the hologram recording medium with only the reference beam so as to reproduce a hologram on each deficient portion; irradiating the recording region with a portion of the information beam, and the reference beam, so as to form a moving spot including a blank in a central portion thereof; detecting a diffracted beam thereby generated by the diffraction grating; and adjusting, based on the detection result, the sight target of only the reference beam to the deficient portion which serves as the reproducing position.

### BRIEF DESCRIPTION OF THE DRAWINGS

FIG. 1 is a schematic diagram of an overall hologram recorder/reproducer according to an embodiment of the present invention;

FIG. 2 is a fragmentary perspective view of the hologram recorder/reproducer shown in FIG. 1;

FIG. 3 illustrates the optical effect of the hologram recorder/reproducer shown in FIG. 1;

FIG. 4 illustrates the optical effect of the hologram recorder/reproducer shown in FIG. 1;

FIG. 5 is a fragmentary plan view of a hologram recording medium according to another embodiment of the present invention; and

FIG. 6 is a fragmentary plan view of a hologram recording medium according to still another embodiment of the present invention.

### BEST MODE FOR CARRYING OUT THE INVENTION

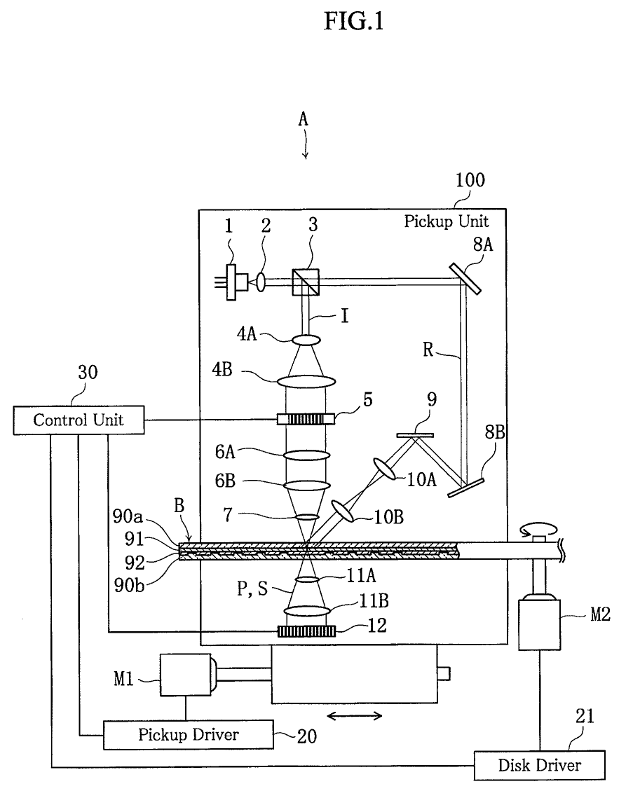

Preferred embodiments of the present invention will be described below with reference to the accompanying drawings. FIGS. 1 to 4 depict an embodiment of a hologram recorder/reproducer according to the present invention.

As shown in FIG. 1, the hologram recorder/reproducer A is configured to record a hologram on a disk-shaped hologram recording medium B, and further to reproduce the recorded hologram by a transmission method. The hologram recorder/reproducer A includes optical system constituting parts such as a light source 1, a collimator lens 2, a beam splitter 3, beam expanders 4A, 4B, a spatial light modulator 5, relay lenses 6A, 6B, an objective lens 7, fixed mirrors 8A, 8B, a reference mirror 9, reference lenses 10A, 10B, receiving lenses 11A, 11B, and a photodetector 12. The optical system is incorporated in a pickup unit 100. The pickup unit 100 is designed to reciprocate by a driving motor M1 for sliding motion, radially of the hologram recording medium B. The hologram recording medium B is made to rotate by a driving motor M2 for rotating motion. As electrical components, the hologram recorder/reproducer A includes a pickup driver 20 to control the driving motor M1 for sliding motion so as to drive the pickup unit 100, a disk driver 21 that controls the driving motor M2 for rotating motion so as to drive the hologram recording medium B, and a control unit 30 connected to the pickup driver 20 and the disk driver 21, as well as to the spatial light modulator 5 and the photodetector 12.

The light source 1 is constituted of, for example, a semiconductor laser device, and emits a laser beam in a form of coherent light. The wavelength λ of the laser beam is approximately 650 nm, for example. The collimator lens 2 converts the laser beam emitted by the light source 1 into a parallel light. The parallel light output by the collimator lens 2 is led to the beam splitter 3. The beam splitter 3 splits the parallel light incident thereon into a information beam I directed to the spatial light modulator 5 and a reference beam R directed to the reference mirror 9 through a different optical path. The beam expanders 4A, 4B are composed of combined lenses, and serve to lead the information beam I to the spatial light modulator 5 while expanding the flux diameter of the information beam I.

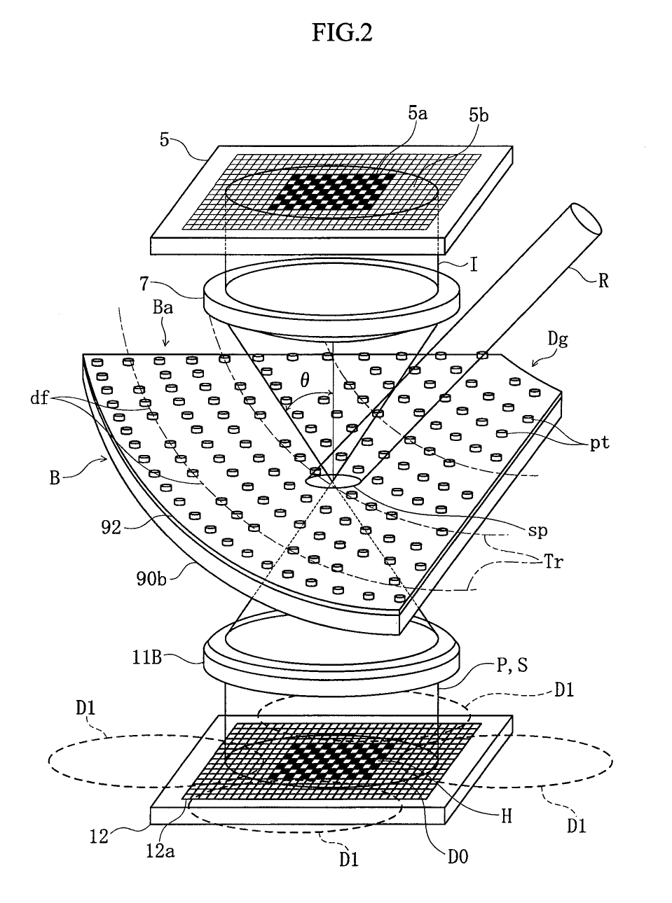

The spatial light modulator 5 is constituted of, for example, a transmissive liquid crystal device, and modulates the information beam I incident thereon into a transmitted light having a two-dimensional pixel pattern, to output such light. As shown in FIG. 2, the spatial light modulator 5 includes a rectangular modulating region 5a that substantially executes the modulation, and a frame-shaped peripheral region 5b located along the outer periphery of the modulating region 5a. The information beam I is transmitted through the spatial light modulator 5, maintaining a diameter expanded as far as the peripheral region 5b while being transmitted through the entire modulating region 5a. The information beam I output by the spatial light modulator 5 is emitted onto the front surface of the hologram recording medium B, through the relay lens 6A, 6B (not shown in FIG. 2) and the objective lens 7.

The reference beam R output by the beam splitter 3 is led to the reference mirror 9 through the fixed mirrors 8A, 8B, and upon being reflected by the reference mirror 9 reaches the front surface of the hologram recording medium B through the reference lenses 10A, 10B. As shown in FIG. 2, the reference beam R is emitted onto the front surface of the hologram recording medium B at a different incident angle from that of the information beam I. Accordingly, in a recording process, the information beam I and the reference beam R are emitted onto the front surface of the hologram recording medium B with mutual interference, and thereby the hologram is formed.

Upon emitting the information beam I, or the reference beam R in a reproducing process, onto the front surface of the hologram recording medium B, a reconstruction beam P and a servo beam S are output from the rear surface of the hologram recording medium B. In the case where the hologram is already recorded, the reconstruction beam P is generated when only the reference beam R is emitted. The servo beam S is generated when at least one of the information beam I and the reference beam R is emitted. As shown in FIG. 2, the reconstruction beam P and the servo beam S are received by the photodetector 12 through the receiving lenses 11A, 11B (11A is not shown in FIG. 2). The control unit 30 controls the pickup driver 20 and the disk driver 21, based on the detection signal (servo signal) output from the photodetector 12 according to the servo beam S. To be more detailed, when the hologram is to be recorded or reproduced, the movement of the pickup unit 100 and the rotation of the hologram recording medium B are subjected to a servo control, such that the information beam I and the reference beam R are emitted onto a desired position. Here, the information beam I provides a relatively large servo signal upon being directly diffracted, and hence the servo control is primarily executed by emitting the information beam I.

As shown in FIG. 1, the hologram recording medium B includes a recording layer 91 and a diffraction grating layer 92 interleaved between cover layers 90a, 90b located on the side of the front surface and the rear surface, respectively. As shown in FIG. 2, on the hologram recording medium B, a spot sp of condensed light is formed on the side of the front surface of the recording region Ba, while the reconstruction beam P and the servo beam S are output from the side of the rear surface of the recording region Ba. The recording layer 91 is composed of a photosensitive material that reacts with a laser beam of a predetermined wavelength, and located on the front surface side from the diffraction grating layer 92. On the recording layer 91, the information beam I and the reference beam R are made incident at a predetermined intersection angle, so as to form a hologram having an interference fringe pattern according to the intersection angle. Upon irradiating the region on the recording layer 91 where the hologram is recorded, the reconstruction beam P according to the interference fringe pattern is generated, and such reconstruction beam P is output from the rear surface.

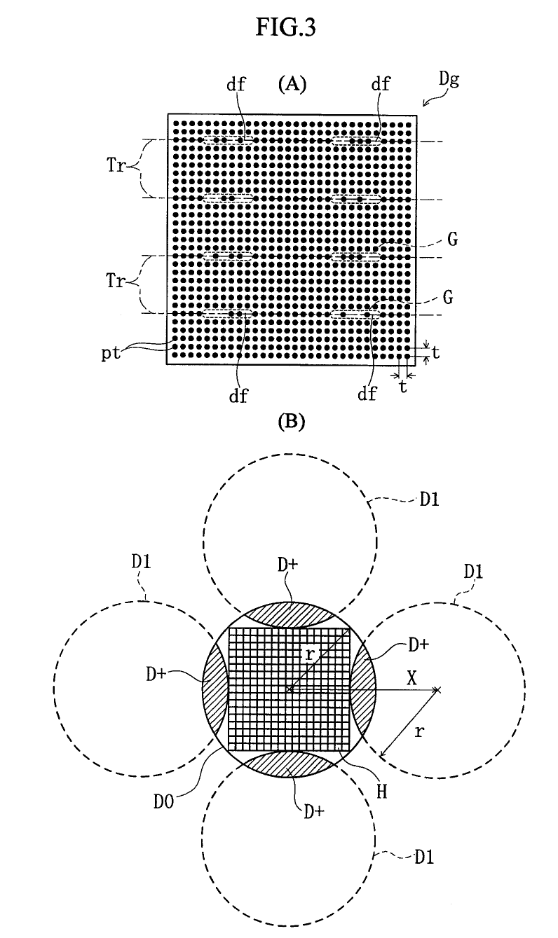

As shown in FIGS. 2 and 3(A), the diffraction grating layer 92 is constituted of a layer on which quite fine recessed and projecting portions are provided so as to form a diffraction grating Dg, and located on the rear surface side of the recording layer 91 (not shown in FIGS. 2 and 3(A), 3(B)). The diffraction grating Dg is formed of minute portions projecting toward the front surface (hereinafter, pit) pt aligned at a predetermined interval t. The diffraction grating Dg includes deficient portions df discretely located so as to serve as a sight target for the condensation spot sp of the information beam I and the reference beam R. Since no pit pt is formed in the deficient portion df, the information beam I and the diffracted beam from the hologram are transmitted without being blocked by the pit pt. Thus, the deficient portion df serves as a position where the hologram information can be efficiently extracted. Here, the diffraction grating may be formed of a multitude of recessed portions aligned horizontally and vertically at regular intervals. In this case, the deficient portions are discretely located, as positions where the recessed portion is not provided.

When viewed from the side of the front surface of the hologram recording medium B, the deficient portions df are aligned along a track Tr formed circumferentially of the recording medium. As shown in FIG. 3(A) in particular, in each track Tr a plurality of groups G, consisting of a predetermined number of deficient portions df and pits pt, is formed, such that the groups G are arranged at a predetermined interval. The arrangement pattern of each group G, defined by how the deficient portions df and the pits pt are aligned, is different from each other. The arrangement pattern of each group G represents the address information corresponding to a rotational position on the track Tr.

With the diffraction grating Dg thus configured, when the information beam I or the reference beam R is emitted onto the front surface, a zero-order diffracted beam D0 and a first-order diffracted beam D1 are generated on the rear surface. The zero-order diffracted beam D0 includes a hologram region H corresponding to the modulating region 5a of the spatial light modulator 5. The zero-order diffracted beam D0 and the first-order diffracted beam D1 are received by the photodetector 12 as a servo beam S. The photodetector 12 includes a detection region 12a capable of detecting at least the entirety of the zero-order diffracted beam D0.

As shown in FIG. 3(B), the grating interval t of the diffraction grating Dg is determined by the following equation (1) , in which r represents the diameter of the zero-order diffracted beam D0 and the first-order diffracted beam D1, X the distance between centers of the zero-order diffracted beam D0 and the first-order diffracted beam D1, λ the wavelength of the laser beam, and NA the numerical aperture of the objective lens 7. Here, the numerical aperture NA is defined by NA=n sinθ, in which θ represents the half angle of a maximal cone angle of a beam incident on the hologram recording medium B from the objective lens 7 (Ref. FIG. 2), and n the refractive index of a medium (generally, air) through which the beam from the objective lens 7 proceeds.

$$t = \frac{λ \times r}{NA \times X} \qquad ( 1 )$$

In this embodiment, the grating interval t is set such that the zero-order diffracted beam D0 and the first-order diffracted beam D1 overlap each other in the peripheral region D+; that the hologram region H included in the zero-order diffracted beam D0 becomes maximal; and that the peripheral region D+ is excluded from the hologram region H. Accordingly, the grating interval t is set such that the following equation (3) is satisfied upon substituting the following conditional formula (2) in the foregoing equation (1).

$$\begin{matrix}X = r + \frac{r}{\sqrt{2}} & ( 2 ) \\ t = \frac{λ \sqrt{2}}{NA ( 1 + \sqrt{2} )} & ( 3 )\end{matrix}$$

In the case where, for example, the wavelength λ is 650 nm and the numerical aperture NA is 0.65, the grating interval t is to be set as approximately 0.586 μm, according to the above equation (3). In addition, a minimum necessary condition with respect to the grating interval is that the zero-order diffracted beam and the first-order diffracted beam overlap each other in the peripheral region, and that the peripheral region is excluded from the hologram region.

As shown FIG. 3(B), the peripheral region D+, where the zero-order diffracted beam D0 and the first-order diffracted beam D1 overlap, is uniformly created along four arcuate portions of the zero-order diffracted beam D0, when the information beam I or the reference beam R is emitted correctly targeted at the pit pt and the deficient portion df. On the other hand, in the case where the information beam I or the reference beam R is emitted onto a position deviated from the pit pt and the deficient portion df, the peripheral region D+ is biased depending on the direction of the shift or amount of deviation. The photodetector 12 serves to detect such deviation of the peripheral region D+, so that the control unit 30 may execute the servo control for positioning the condensation spot sp.

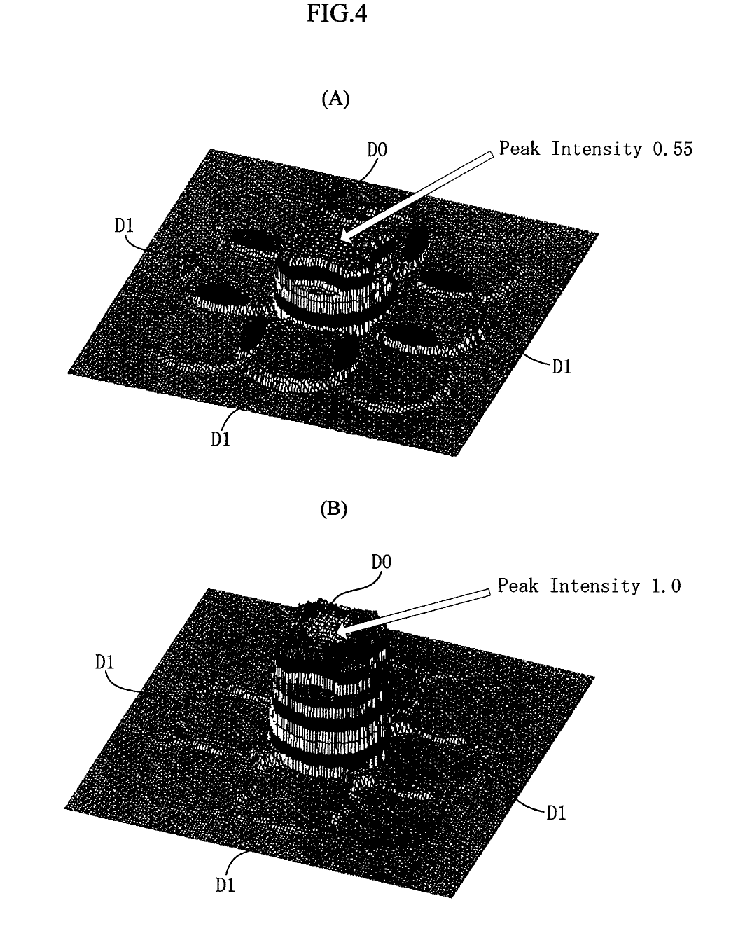

As shown in FIG. 4(A) as a result of a simulation test, in the case where the information beam I is targeted at the pit pt, the peak intensity of the zero-order diffracted beam D0 detected by the photodetector 12 becomes approximately 0.55. In contrast, in the case where the information beam I is targeted at the deficient portion df, the peak intensity of the zero-order diffracted beam D0 detected by the photodetector 12 becomes approximately 1.0, as shown in FIG. 4(B). This means that in the case where the beam emitted onto the diffraction grating Dg is transmitted through the pit pt, the beam is blocked by the pit pt thereby incurring degradation in intensity of the zero-order diffracted beam D0, while in the case where the beam is transmitted through the deficient portion df, the zero-order diffracted beam D0 barely incurs degradation in intensity. Accordingly, the control unit 30 moves the pickup unit 100 radially of the hologram recording medium B while rotating the hologram recording medium B at a high speed, thereby identifying the track Tr that includes the deficient portion df based on the intensity of the zero-order diffracted beam D0 detected by the photodetector 12.

To be more detailed, the servo control is executed as described below, in each of the recording and reproducing process. Here, during the execution of the servo control, the information beam I is condensed instantaneously for a much shorter time than an ordinary duration of the irradiation, or with a beam too faint to be detected, so that a hologram is kept from being recorded on the recording layer 91 during the execution of the servo control.

In the recording process, the control unit 30 first acquires information on the track and the address of the deficient portion df where the hologram is to be recorded. The track information is, for example, the track number serially given to each track Tr from an inner circumferential one toward an outer circumferential one. The address information represents, for example, a physical position on each track Tr along a circumferential direction of each group G.

Then the control unit 30 moves the pickup unit 100 in a predetermined direction while irradiating the hologram recording medium B rotating at a high speed with the information beam I. At this moment, the spatial modulator 5 is driven so that all the pixels in the peripheral region 5b and in the modulating region 5a transmit the beam. As a result, the hologram recording medium B is irradiated with the information beam I having sufficient intensity, and the zero-order diffracted beam D0 is generated with definitely distinctive difference in intensity between the portion of the information beam I that accurately hits the track Tr and that deviated therefrom. Accordingly, the control unit 30 stops the pickup unit 100 at a predetermined position based on the intensity of the zero-order diffracted beam D0 detected by the photodetector 12, so as to adjust the target point of the information beam I to the target track Tr designated by the track information.

Thereafter, the control unit 30 irradiates the hologram recording medium B rotating at a constant speed with the information beam I, while holding the pickup unit 100 at the predetermined position. In this process also, all the pixels in the modulating region 5a and in the peripheral region 5b are driven to transmit the beam, so that the hologram recording medium B is irradiated with the information beam I having sufficient intensity. As a result, the photodetector 12 detects the zero-order diffracted beam D0 having different intensity between a portion of the information beam I that hits the group G and a portion thereof that hits the pits pt other than those of the group G. Thus, the control unit 30 stops the rotation of the hologram recording medium B based on the servo signal output by the photodetector 12 in a waveform according to the intensity of the zero-order diffracted beam D0, so as to adjust the target point of the information beam I to the target group G designated by the address information.

The control unit 30 then micro-adjusts the displacement position of the pickup unit 100 and the rotational stop position of the hologram recording medium B, so that the information beam I accurately hits the target deficient portion df in the group G. In this process also, all the pixels in the modulating region 5a and in the peripheral region 5b are driven to transmit the beam, so that the hologram recording medium B is irradiated with the information beam I having sufficient intensity. The photodetector 12 detects the four peripheral regions D+ where the zero-order diffracted beam D0 and the first-order diffracted beam D1 overlap, in regions of four different directions. As a result, the control unit 30 micro-adjusts the displacement position of the pickup unit 100 and the rotational stop position of the hologram recording medium B based on the servo signal output by the photodetector 12 in a waveform according to the deviation of the peripheral region D+, so that the condensation spot sp is accurately positioned at the target deficient portion df. Thus, with the target deficient portion df, the irradiation points of the information beam I and the reference beam R coincide. Here, the target deficient portion (portion where the hologram is to be recorded) may be located at a specific position in a predetermined group, or at all the deficient portions included in the group.

Once the condensation spot sp is finally positioned at the target deficient portion df, the spatial modulator 5 forms a pixel pattern according to the recording information in the modulating region 5a, and the target deficient portion df is irradiated with the information beam I and the reference beam R including the pixel pattern, for a predetermined irradiation time. Thus, the condensation spot sp is positioned at the target deficient portion df, so that the hologram is recorded on the recording layer 91 corresponding to that deficient portion df. At this moment, the peripheral region 5b of the spatial modulator 5 may be driven so that all the pixels in the peripheral region 5b inhibit transmission of the beam.

In the reproducing process, basically the same procedure is taken for executing the servo control. More specifically, the control unit 30 acquires information on the track and the address of the deficient portion df where the hologram is to be reproduced, and moves the pickup unit 100 in a predetermined direction while irradiating the hologram recording medium B rotating at a high speed with the information beam I and the reference beam R. In this process, unlike in the recording process, the spatial modulator 5 is driven so that all the pixels in the modulation region 5a inhibit transmission of the beam, while the hologram recording medium B is irradiated with the information beam I and the reference beam R. In other words, in the servo control in the reproducing process, the information beam I and the reference beam R are emitted so as to form only the four peripheral regions D+. In this case also, the four peripheral regions D+ are generated with definitely distinctive difference in intensity between the portion of the information beam I and the reference beam R that accurately hits the track Tr and that deviated therefrom, and hence the control unit 30 can stop the pickup unit 100 at a predetermined position based on the intensity of the peripheral region D+ detected by the photodetector 12, so as to adjust the target point of the information beam I and the reference beam R to the target track Tr designated by the track information.

Thereafter, the control unit 30 irradiates the hologram recording medium B rotating at a constant speed with the information beam I and the reference beam R, while holding the pickup unit 100 at the predetermined position. In this process also, all the pixels in the modulating region 5a are driven to inhibit transmission of the beam. As a result, the photodetector 12 detects the peripheral region D+ having different intensity between a portion of the information beam I and the reference beam R that hits the group G and a portion thereof that hits the pits pt other than those of the group G. Thus, the control unit 30 stops the rotation of the hologram recording medium B based on the servo signal output by the photodetector 12 in a waveform according to the intensity of the peripheral region D+, so as to adjust the target point of the information beam I and the reference beam R to the target group G designated by the address information.

The control unit 30 then micro-adjusts the displacement position of the pickup unit 100 and the rotational stop position of the hologram recording medium B, so that the information beam I and the reference beam R accurately hit the target deficient portion df in the group G. In this process also, all the pixels in the modulating region 5a are driven to inhibit transmission of the beam. The photodetector 12 detects the four peripheral regions D+ in regions of four different directions. As a result, the control unit 30 micro-adjusts the displacement position of the pickup unit 100 and the rotational stop position of the hologram recording medium B based on the servo signal output by the photodetector 12 in a waveform according to the deviation of the peripheral region D+, so that the reference beam R is accurately positioned at the target deficient portion df. Thus, in the servo control in the reproducing process only the peripheral region D+ is detected, which enables accurately detecting the peripheral region D+ without being affected by the interference fringe pattern of the hologram in the deficient portion df where the hologram is already recorded, thereby facilitating identifying the target deficient portion df, only with the peripheral region D+. It is to be noted that the servo control in the recording process may also be executed so as to detect only the peripheral region.

Once the positioning with the target deficient portion df is finally achieved, the target deficient portion df is irradiated with the reference beam R. Thus, upon irradiating the target deficient portion df with the reference beam R, the hologram reconstruction beam is generated from the portion of the recording layer 91 corresponding to that deficient portion df, so that the photodetector 12 detects the reconstruction beam, to thereby reproduce the hologram.

As described above, in the hologram recorder/reproducer A according to this embodiment, the optical system including the light source 1 and the photodetector 12 necessary for recording and reproducing the hologram can be employed for executing the servo control, which allows simplifying the optical system. Through the servo control, the information beam I and the reference beam R can be accurately positioned at the desired deficient portion df, utilizing the zero-order diffracted beam D0 and the first-order diffracted beam D1.

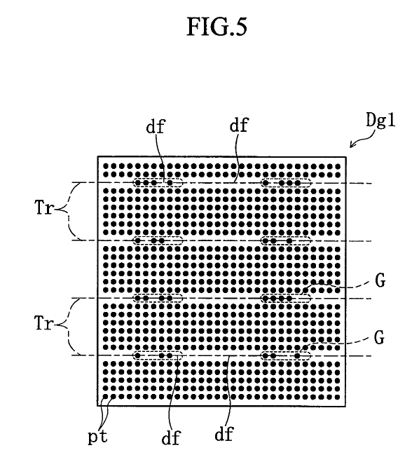

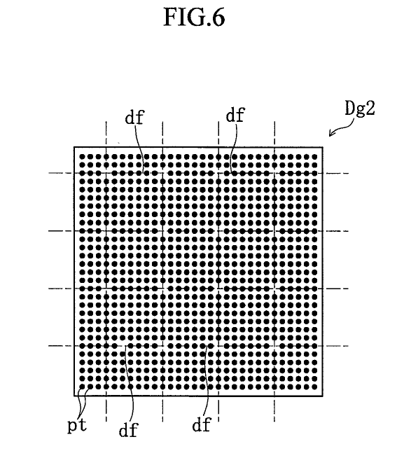

In another embodiment, the hologram recording medium may have a diffraction grating as shown in FIGS. 5 and 6.

The diffraction grating Dg1 shown in FIG. 5 includes the deficient portions df generally continuously provided along the track Tr, on which a plurality of groups G is aligned at a predetermined interval. The hologram recording medium having such diffraction grating Dg1 allows identifying the track Tr more quickly and more accurately.

In the diffraction grating Dg2 shown in FIG. 6, the deficient portions df are aligned horizontally and vertically at regular intervals. The hologram recording medium having such diffraction grating Dg2 is appropriate for those hologram recorder/reproducers that move the optical system horizontally and vertically, because simply giving an orthogonal coordinate enables identifying the target deficient portion df.

It is to be understood that the present invention is in no way limited to the foregoing embodiment.

Although the information beam and the reference beam are emitted for executing the servo control in the reproducing process in the foregoing embodiment, only the information beam may be employed for the servo control, in the reproducing process.

The layer on which the diffraction grating is formed by recessed and projecting portions may be replaced by a simple light reflecting layer.

The diffraction grating may be formed of portions having different refractive indices corresponding to the recessed or projecting portions, rather than the geometrically configured structure of recesses or projections.

1. A hologram recording medium comprising a recording region on which a light condensation spot is formed upon being irradiated with an information beam or a reference beam, with a hologram recorded at each condensation spot,
wherein the recording region includes a diffraction grating in which a plurality of deficient portions are formed for serving as a sight target for the condensation spot.

2. The hologram recording medium according to claim 1, wherein a grating interval of the diffraction grating is set such that a zero-order diffracted beam and a first-order diffracted beam generated when the information beam or the reference beam is emitted overlap each other in a peripheral region.

3. The hologram recording medium according to claim 1 or 2, wherein the plurality of deficient portions are provided at regular intervals.

4. The hologram recording medium according to claim 1 or 2, wherein the plurality of deficient portions are provided so as to form a plurality of rows.

5. The hologram recording medium according to claim 1 or 2, wherein the plurality of deficient portions are divided into a plurality of groups, such that each group has a different arrangement pattern.

6. The hologram recording medium according to claim 1 or 2, wherein the diffraction grating is formed of a plurality of projections or recessed portions aligned at regular intervals, the deficient portion being a region where the projection or the recessed portion is locally unprovided.

7. A hologram recording and reproducing apparatus, comprising: a hologram recording medium including a recording region on which a condensation spot is formed upon being irradiated with an information beam or a reference beam, and a diffraction grating formed on the recording region and including a plurality of deficient portions that serve as a sight target for the condensation spot, so that a hologram is recorded on each of the deficient portions; an information beam emitter that emits the information beam to the hologram recording medium; a reference beam emitter that emits the reference beam to the hologram recording medium; and an optical receiver that receives a reconstruction beam output by the hologram recording medium for reconstruction;
the apparatus further comprising: a control unit that irradiates, in a recording process, the recording region with the information beam or the reference beam so as to form a moving spot thereon, and causes the optical receiver to receive a diffracted beam thereby created by the diffraction grating, so as to adjust the focal point of the information beam and the reference beam at the deficient portion where recording is to be executed, based on a detection signal from the optical receiver.

8. The hologram recording and reproducing apparatus according to claim 7, wherein the control unit irradiates, in a reproducing process, the recording region with a part of the information beam and the reference beam so as to form the moving spot including a blank at a central portion, and causes the optical receiver to receive the diffracted beam created by the diffraction grating, thereby adjusting the focal point of only the reference beam at the deficient portion, based on the detection signal from the optical receiver.

9. A hologram recording method, comprising: employing a hologram recording medium including a recording region on which a condensation spot is formed upon being irradiated with an information beam or a reference beam, and a diffraction grating formed on the recording region and including a plurality of deficient portions that serve as a sight target of the condensation spot; irradiating the hologram recording medium with the information beam or the reference beam so as to record a hologram on each of the deficient portions;
the method further comprising: irradiating the recording region with the information beam or the reference beam so as to form a moving spot; detecting a diffracted beam thereby generated by the diffraction grating; and adjusting, based on the detection result, the sight target of the information beam and the reference beam to the deficient portion which serves as the recording position.

10. A hologram reproducing method, comprising: employing a hologram recording medium including a recording region on which a condensation spot is formed upon being irradiated with an information beam or a reference beam, and a diffraction grating formed on the recording region and including a plurality of deficient portions that serve as a sight target of the condensation spot, each of the deficient portions including a hologram recorded thereon; irradiating the hologram recording medium with only the reference beam so as to reproduce a hologram on each deficient portion;
the method further comprising: irradiating the recording region with a portion of the information beam, and the reference beam, so as to form a moving spot including a blank in a central portion thereof; detecting a diffracted beam thereby generated by the diffraction grating; and adjusting, based on the detection result, the sight target of only the reference beam to the deficient portion which serves as the reproducing position.
